(19) United States
(12) Patent Application Publication
(10) Pub. No.: US 2004/0044738 A1
(43) Pub. Date: Mar. 4, 2004

(54) Client administration method and device

(75) Inventors: Takashi Ohno, Kawasaki (JP); Shingo Fujimoto, Kawasaki (JP); Yuki Yamamoto, Kawasaki (JP); Jun Kakuta, Kawasaki (JP); Masahiko Murakami, Kawasaki (JP); Sumiyo Okada, Kawasaki (JP); Akinori Iwakawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/633,555

(22) Filed: Aug. 5, 2003

(30) Foreign Application Priority Data
Aug. 30, 2002 (JP) 2002-254828

(51) Int. Cl. G06F 15/16

(52) U.S. Cl. 709/206; 709/227

(57) ABSTRACT

Change of an identifier is reported without causing trouble to user agents. When a user agent A changes an identifier “A1” of a client 2a that he/she operates, notification recipients of a new identifier “A2” are automatically decided and the notification is carried out accordingly. It is desired that the recipients of the new identifier be preferably determined so as not to include unnecessary notification recipients, taking their relationship with the user agent A into consideration. For this reason, the maximum range of the notification recipients of the identifier is limited to be within watchers of the user agent A. The watchers are the notification recipients of user agent A's presence information, and therefore, it is assumed that there is little need for the identifier to be told to others who are not the watchers.

### BACKGROUND OF THE INVENTION

1. Field of the Invention

The present invention relates to presence systems which enable a user to refer to presence information of other users on a network.

In the present invention, a presence system includes a server and clients. The server stores presence information of a user agent who operates a client, and distributes the presence information to other clients. The owner of the distributed presence information is referred to as a “presentity”. The operator of a client that receives the presence information of the presentity is referred to as a “watcher”. Presence information means any information related to the presentity, and may include text messages (hereafter referred to as “instant messages”) and icon files that indicate status of the presentity, personal information that indicates residential addresses or communication addresses, and the like.

2. Description of the Related Art

Instant messages can be transmitted as long as the identifier of the party on the other end to whom the message is directed is known. In recent years, unsolicited mails called “spam” have become a problem in e-mail environment. Instant messages in presence systems are also susceptible to similar problems. Most senders of unsolicited mails generate identifiers randomly and attempt to transmit messages using the identifiers. If the transmission is successful, the identifiers are stored as valid and are used for the subsequent transmissions. Thus, after receiving an unsolicited message even only once, ordinary user agents will subsequently receive such messages one after another. A first conceivable solution to this problem is to use an access control function. This function essentially uses two kinds of lists, a permission list and a rejection list. In the permission list, the identifiers of user agents P1, P2, P3 . . . who are permitted to send messages to a user agent A are registered. In this case, instant messages from any other user agents who are not registered in the permission list are rejected. Consequently, the quantity of unsolicited instant messages is reduced. In the rejection list, the identifiers of user agents R1, R2, R3 . . . who are denied sending messages to the user agent are registered. If a user agent who has sent an unsolicited message is registered in the rejection list, it is possible to avoid receiving subsequent unsolicited messages therefrom.

However, in the foregoing first method, all the user agents who are potentially senders of messages have to be registered in the permission list. In addition, most of the senders of unsolicited mails change their identifiers one after another, in which case the rejection list becomes ineffective.

In view of this, a second conceivable solution is such that the user agent obtains a new identifier from the presence system as a new registration, and at the same time, undergoes a procedure to stop the access to the services that he/she has used with the old identifier. This method has an advantage in that the user agent him/herself can change his/her identifier to prevent the receipt of unsolicited messages. However, it is undesirable that all information of various kinds in the presence system that has been associated with the old identifier, such as his/her presence information, buddy lists, access levels, and so forth, have to be discarded because of the procedure to stop the access to the services.

More specifically, when a user agent A changes his/her identifier in the presence system, another user agent B cannot use the old identifier and there is no means for the user agent B to know the new identifier. Thus, the user agent B is deprived of any means for identifying the user agent A who has changed his/her identifier. It may be possible for the user agent A who has changed his/her identifier to notify each necessary user agent of the change of the identifier, but this requires the user agent A to take much trouble and spend much time, placing heavy burden on the user agent A.

In view of the foregoing and other problems, it is an object of the present invention to enable the user agent to report a change of his/her identifier to other user agents when the user agent changes his/her identifier, without placing burden on the user agent.

It is another object of the present invention to automatically report an identifier that has been changed to required user agents when the user agent changes his/her identifier in a presence system.

### BRIEF SUMMARY OF THE INVENTION

In order to accomplish the foregoing and other objects, the present invention provides, in accordance with a first aspect, a client administration method of administering a group of clients. Each of the clients provides presence information. This method comprises the following steps: a presence-storing step of accepting a setting of presence information of the clients including a first client and storing the presence information client by client; a notification recipient-storing step of storing identifiers of watcher clients for respective clients; each of the watcher clients being provided with the presence information of at least one of the clients in the clients group; an identifier-changing step of accepting a change of the identifier of the first client; a decision step of deciding a watcher client of the first client or at least one of a plurality of watcher clients of the first client to be one or more identifier notification recipients according to the change of the identifier of the first client; and an identifier-transmitting step of transmitting a new identifier of the first client to one or more identifier notification recipients decided in said decision step.

When a user agent A changes the identifier of a client that he/she operates, notification recipients of a new identifier are automatically decided and the notification is carried out. It is desirable that the notification recipients of the new identifier be decided so as not to include unnecessary notification recipients, taking the relationship with the user agent A into consideration. For this reason, the maximum range of the identifier notification recipients is limited to the watchers of the user agent A. It can be assumed that there is little need for the identifier to be told to others who are not the watchers. This is because the watchers are the notification recipients of user agent A's presence information.

Preferably, in the above-described method, in the decision step, all of a plurality of watcher clients of the first client to be identifier notification recipients according to the change of the identifier of the first client.

There are cases where the user agent A does not necessarily wish to notify all the watchers of his/her new identifier. If this is the case, some of the watchers are extracted excluding those watchers to whom the notification of the identifier can be considered unnecessary, and are decided to be the identifier notification recipients. Examples of the extraction method include a) extracting the watchers who frequently receives the presence information of the user agent A, and b) extracting the watchers who frequently reports their presence information to the user agent A.

The above-described method may further comprises a subscriber client-storing step of storing identifiers of subscriber clients so that each subscriber client is associated with at least one client that provides the presence information thereto, the subscriber client being provided with the presence information of at least one client of the clients group; and said decision step deciding a client to be an identifier notification recipient, the client being both a watcher client of the first client and a subscriber client of the first client.

There are cases where the user agent A does not necessarily wish to notify all the watchers of his/her new identifier. If this is the case, those user agents who are buddies and watchers of the user agent A are made the identifier notification recipients. Accordingly, the new identifier is not told to those watchers who are inappropriate as the identifier notification recipients. The inappropriate watchers may include, for example, those watchers who do not permit the user agent A to be notified of their presence information.

The above-described method may further comprises a presence-notifying step of notifying the first client's watcher client of new presence information according to the setting of the presence information; a notification history-storing step of storing a notification history of the presence information; and said decision step extracting at least one of a plurality of watcher clients of the first client based on the notification history, and deciding to be one or more identifier notification recipients.

In the decision step of this method, some of the watcher clients of the first client are extracted based on the notification history and are decided to be the identifier notification recipients. For example, the new identifier is reported to, among watchers of the user agent A, watchers who have notified their presence information in the past. For example, when the presence information of user agent X does not change, the presence information is not transmitted to the user agent A even if the user agent X is a buddy of the user agent A. It can be considered that the necessity of notifying such a user agent X of the identifier is relatively low.

The above-described method may further comprises a messaging step of administering distribution of text messages exchanged between the clients; a distribution history step of storing a distribution history of distributed text messages; and said decision step extracting at least one of a plurality of watcher clients of the first client based on the distribution history, and deciding to be one or more identifier notification recipients.

There are cases where the user agent A does not necessarily wish to notify all the watchers of his/her new identifier. If this is the case, for example, the clients of those user agents who are watchers and have exchanged text messages with the user agent A are decided to be the identifier notification recipients. This is because it can be assumed that such user agents have a relatively close relationship with the user agent A. It is also possible to decide whether a user agent is decided to be an identifier notification recipient according to the frequency or the number of times of exchanging text messages with the user agent A.

Preferably, in the above-described method, in the presence-storing step, said presence-storing step storing the presence information of the clients so that the presence information is associated with an access level, the access level limiting notification recipients of the presence information of the clients; said notification recipient-storing step further storing the access level of each watcher client; and said decision step deciding a portion of a plurality of watcher clients of the first client to be the identifier notification recipients based on the access level of each watcher client.

There are cases where the user agent A does not necessarily wish to notify all the watchers of his/her new identifier. If this is the case, it is conceivable that the clients of those user agents who are watchers and have high access levels are assigned as the identifier notification recipients. By determining whether the identifier should be told according to the access level, it is possible to prevent unnecessary identifier notifications.

Preferably, in the above-described method, said identifier-transmitting step further transmitting display data for displaying the change of the identifier of the first client to one or more identifier notification recipients.

It is possible to let those user agents who operate the clients of the identifier notification recipients know that the identifier of the user agent A, whom the users agent are watching, has changed.

Preferably, in the above-described method, said identifier-transmitting step further transmitting attribute information related to the change of the identifier of the first client to one or more identifier notification recipients.

The attribute information may include, for example, text messages stating the reason for changing the account and text messages stating the reason for being extracted as a notification recipient. The user agent who operates the client that has been selected as an identifier notification recipient is thus informed of why the identifier has been changed, or why the new identifier is reported to the user agent.

Preferably, in the above-described method, said identifier-changing step accepting registration of the attribute information.

The user agent who changes his/her identifier can notify his/her acquaintances of, for example, the reason for the change or the like together with the new identifier.

The present invention also provides, a client administration device that administers a group of clients, each client providing presence information, the device comprising: presence-storing unit for accepting a setting of presence information of the clients including a first client, and storing the presence information client by client; notification recipient-storing unit for storing identifiers of watcher clients for respective clients, each of the watcher clients being provided with the presence information of at least one of the clients in the clients group; identifier-changing unit for accepting a change of the identifier of the first client; decision unit for deciding a watcher client of the first client or at least one of a plurality of watcher clients of the first client to be one or more identifier notification recipients according to the change of the identifier of the first client; and identifier-transmitting unit for transmitting a new identifier of the first client to one or more identifier notification recipients decided by said decision unit.

This aspect of the invention has similar effects and advantages to those in the first aspect of the invention.

The present invention provides, in further another aspect, a computer-readable storage medium storing a client administration program for administering a group of clients, each client providing presence information, the program executing: a presence-storing step of accepting a setting of presence information of the clients including a first client, and storing the presence information client by client; a notification recipient-storing step of storing identifiers of watcher clients for respective clients, each of the watcher clients being provided with the presence information of at least one of the clients in the clients group; an identifier-changing step of accepting a change of the identifier of the first client; a decision step of deciding a watcher client of the first client or at least one of a plurality of watcher clients of the first client to be one or more identifier notification recipients according to the change of the identifier of the first client; and an identifier-transmitting step of transmitting a new identifier of the first client to one or more identifier notification recipients decided in said decision step.

This aspect of the invention has similar effects and advantages to those in the first aspect of the invention.

The present invention also provides, in yet another aspect, a client administration program executed by a computer that administers a group of clients, each client providing presence information, the program causing the computer to execute the steps of: a presence-storing step of accepting a setting of presence information of the clients including a first client, and storing the presence information client by client; a notification recipient-storing step of storing identifiers of watcher clients for respective clients, each of the watcher clients being provided with the presence information of at least one of the clients in the clients group; an identifier-changing step of accepting a change of the identifier of the first client; a decision step of deciding a watcher client of the first client or at least one of a plurality of watcher clients of the first client to be one or more identifier notification recipients according to the change of the identifier of the first client; and an identifier-transmitting step of transmitting a new identifier of the first client to one or more identifier notification recipients decided in said decision step.

This aspect of the invention has similar effects and advantages to those in the first aspect of the invention.

The present invention also provides, in still another aspect, a client administration method of administering a group of clients, each client providing presence information, the method comprising: a presence-storing step of accepting a setting of presence information of the clients including a first client, and storing the presence information client by client; information-storing step of storing client-relationship information for respective clients, the client-relationship information containing one or more identifiers of one or more clients relating to provision of presence information of the first client thereto and/or one or more identifiers of one or more clients relating to a request made by the first client, the request being for provision of presence information of those clients to the first client; an identifier-changing step of accepting a change of the identifier of the first client; a decision step of deciding one or more clients to be one or more identifier notification recipients according to the change of the identifier of the first client, one or more identifiers of one or more clients being contained in the client relationship information stored in association with the first client; and an identifier-transmitting step of transmitting a new identifier of the first client to one or more identifier notification recipients decided in said decision step.

The information related to providing of presence information among clients may include, for example, a permission list or a rejection list. The permission list stores the identifiers of clients P1, P2, P3 . . . who are permitted by a client A to refer to the client A's presence information. The rejection list stores the identifiers of clients R1, R2, R3 . . . who are refused by the client A to refer to the client A's presence information. Another examples is the history information that stores the clients that are past recipients of the presence information of a client, and the clients that are the senders of the presence information that was received in the past. Further another example is the history information that stores other clients that a client sent messages to or received messages from in the past. Examples of the information related to the request for obtaining of presence information may include, for example, a buddy list in which a client registers the identifier of other clients who request to refer to his/her presence information.

These types of information represent the relationship between a client and other clients that the client recognizes. Therefore, it is highly likely that the user agents identified by these types of information are those who have a great need to be notified of the new identifier. By determining the identifier of a client contained in any of the information as an identifier change notification recipient, the selection of notification recipients can be easily carried out.

Thus, according to the present invention, when a user agent changes his/her identifier in a presence system, appropriate notification recipients of the new identifier are automatically determined. Therefore, the new identifier can be automatically reported to other user agents without placing burden on the user agent.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

FIG. 1 illustrates an example showing the overall configuration of a presence system including a server according to a first embodiment of the present invention;

FIG. 2 illustrates the concept of a presence table;

FIGS. 3A and 3B show watcher list tables of user agent A who operates a client 2a of FIG. 1;

FIG. 4 shows an example of account change screen;

FIG. 5 shows an example of a screen displayed on a client that receives an account change notification;

FIG. 6 shows an example of a screen displayed on a notified client;

FIG. 7 shows an example of a screen that accepts a setting of a new account and a setting of the reason for changing an account;

FIG. 8 shows an example of a display screen displayed on a client to be notified, which displays attribute information when receiving an account change notification;

FIG. 9 shows an example of a screen that displays a change notification;

FIG. 10 is a flowchart showing an example of the flow of a notification process performed by a server 1;

FIG. 11A shows an example of a screen used for selecting notification recipients of a new account (for selecting individuals); and

FIG. 11B shows an example of a screen used for selecting notification recipients of a new account (for selecting groups).

### DETAILED DESCRIPTION OF THE PREFERRED EMBODIMENTS

First Embodiment

1. Overall Configuration

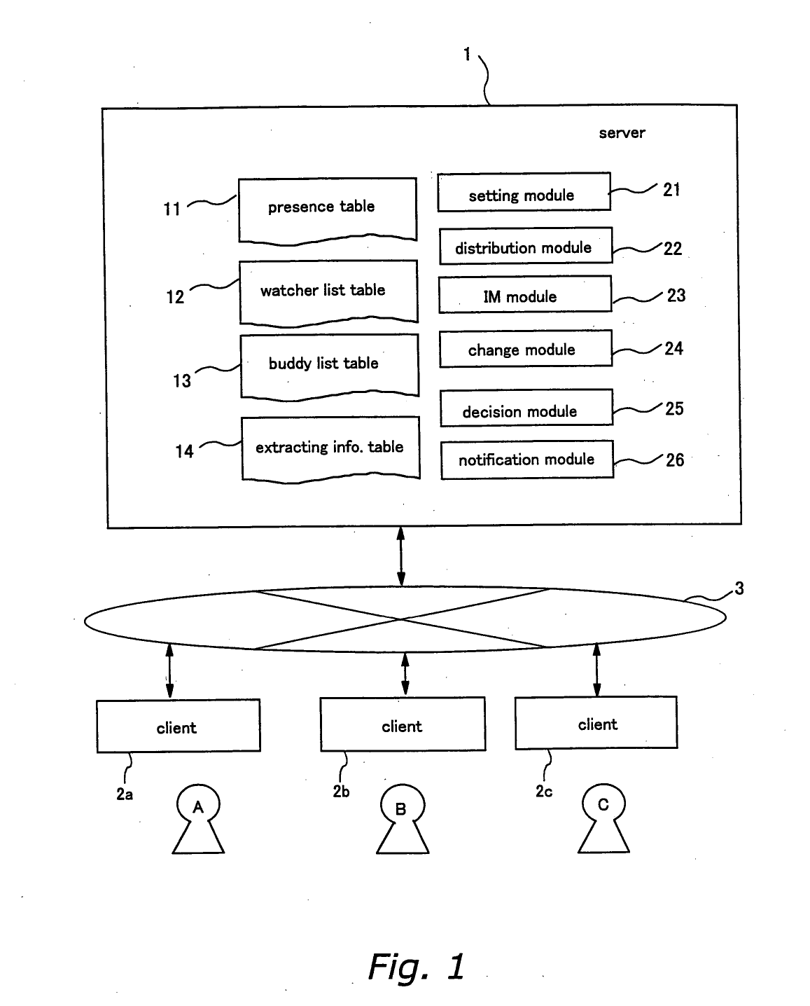

Hereafter, the description discusses an example in which a client administration method according to the present invention is used for a server in a presence system. FIG. 1 shows an example of the overall configuration of the presence system including a server according to one embodiment of the present invention. The presence system includes a server 1 and clients 2a, 2b, 2c, . . . etc., both of which are connected through a network 3. The clients 2a, 2b, 2c . . . etc. (hereafter collectively or individually referred to as “clients 2”) are operated by user agents A, B, C, . . . etc., respectively. Each of the clients 2 is identified by an account (an identifier).

The server 1 administers the presence information on the clients 2. The server 1 has a presence table 11 (presence-storing means), a watcher table 12 (notification recipient-storing means), a setting module 21 (presence-storing means), a change module 24 (identifier-changing means), a deciding module 25 (deciding means), and a notification module 26 (identifier-transmitting means).

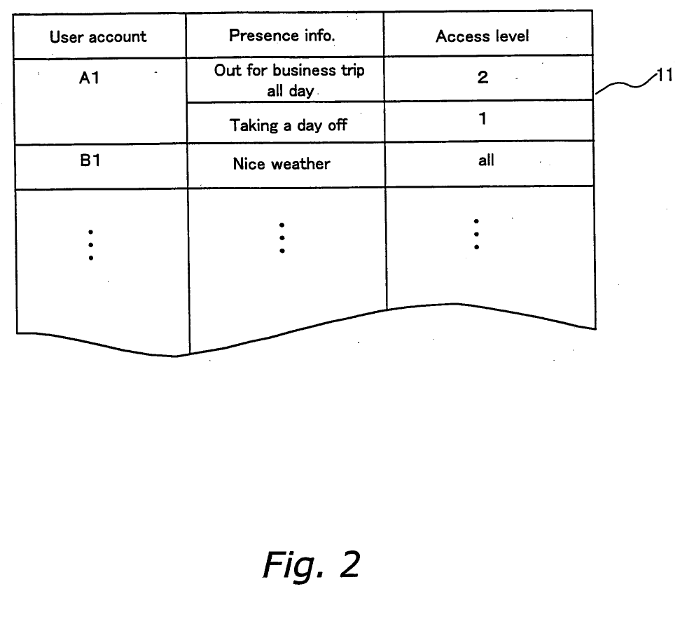

The presence table 11 stores the presence information client by client. FIG. 2 shows a concept of the presence table.

The setting module 21 accepts settings of presence information from the clients 2 and registers them in the presence table 11.

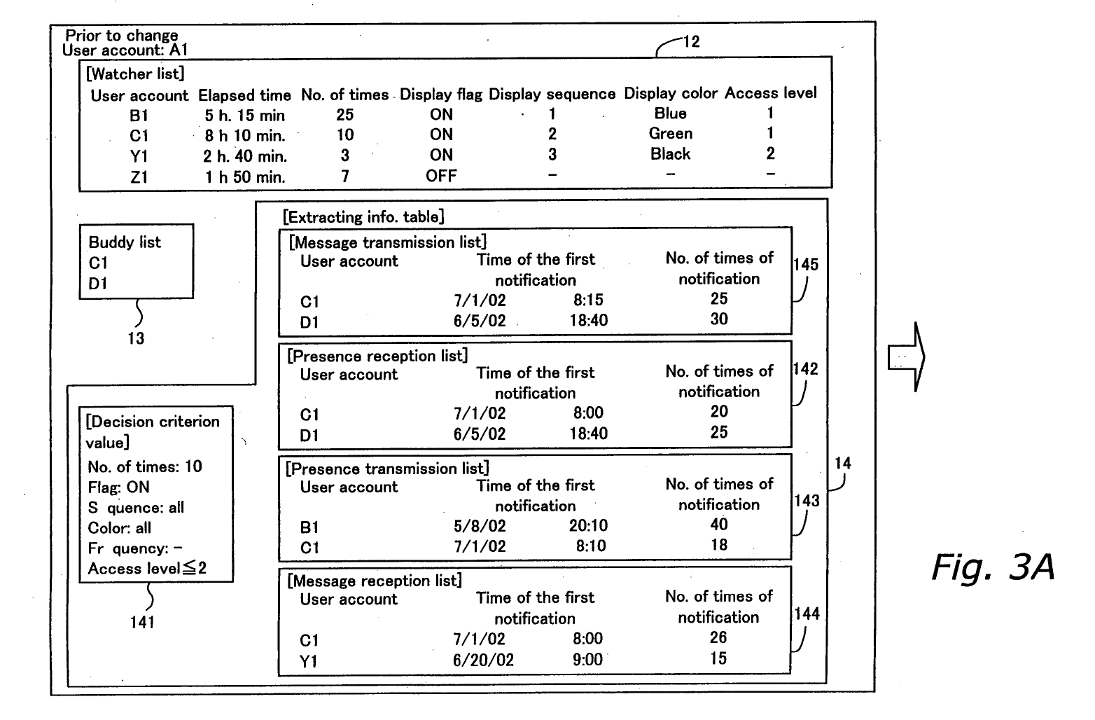

The watcher list table 12 stores accounts of watcher clients for each of the clients 2. The watcher clients are the clients that are notified of presence information of at least one of the clients 2. FIG. 3A and FIG. 3B show an example of the watcher list table of the user agent A who operates a client 2a. In the figures, the account of the user agent A is “A1” in FIG. 3A, while the account is changed into “A2” in FIG. 3B.

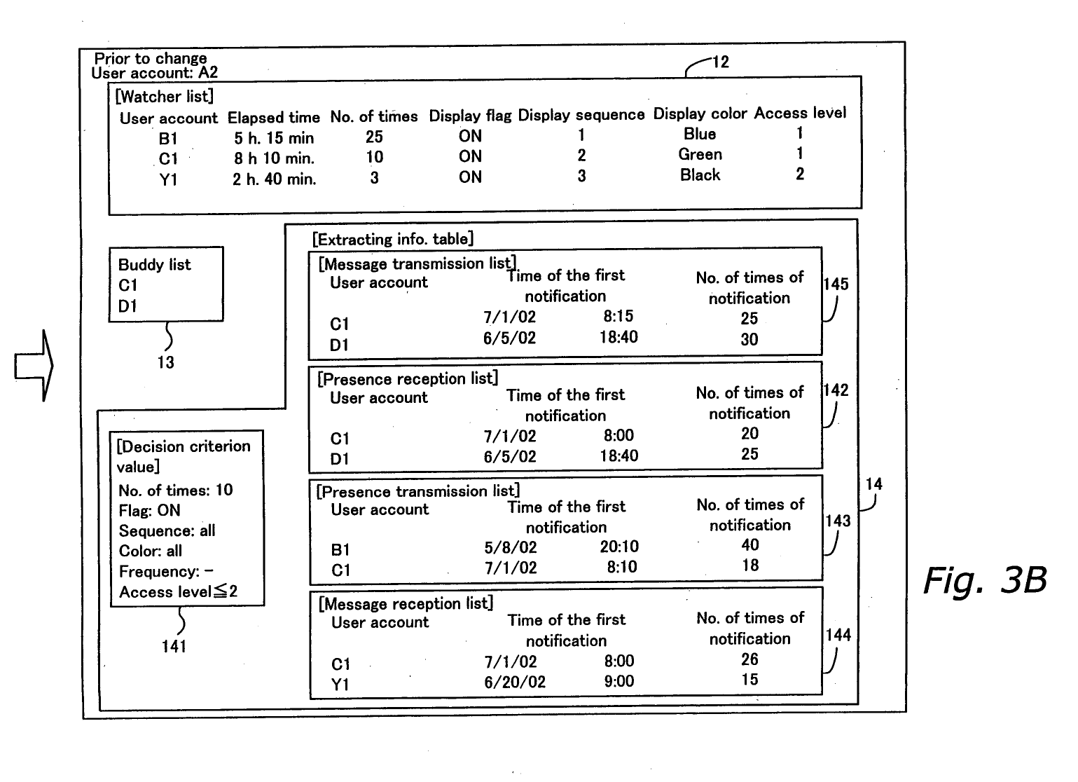

The change module 24 accepts changes to the accounts of the clients 2. For example, the change module 24 provides the account change screen illustrated in FIG. 4 to the clients 2 and accepts changes to the accounts. FIG. 4 shows an example in which the account of the client 2a “A1” is changed to “A2”. Hereinafter, the description discusses, for the sake of convenience in description, an example in which the account of the client 2a operated by the user agent A is changed from “A1” to “A2”.

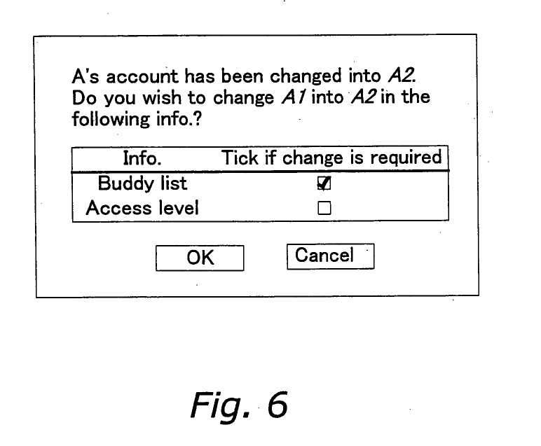

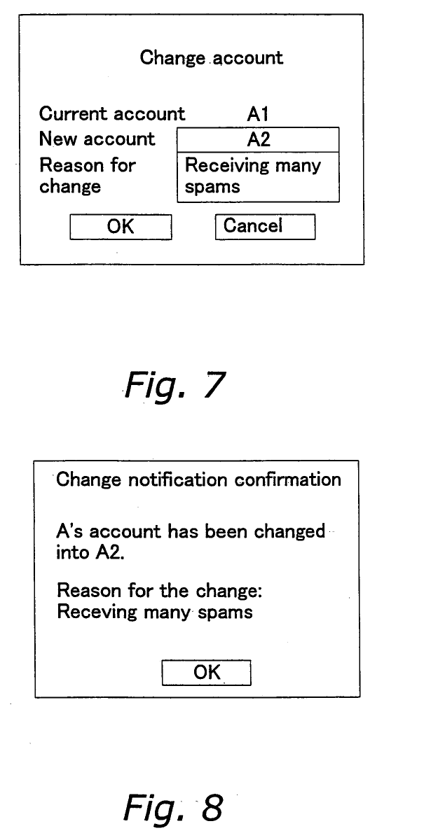

The change module 24 may accept, in addition to accepting changes of the accounts, registration of other related attribute information. For example, the change module 24 provides the screen as illustrated in FIG. 7 to the client 2a, and accepts a setting of a new account and a setting of the reason for changing the account. The change module 24 can notify a notification recipient of the accepted attribute information together with the new account. FIG. 8 shows an example of a display screen showing attribute information, displayed on a client to be notified upon receiving the notification. This screen displays a new account “A2” and the reason for the change.

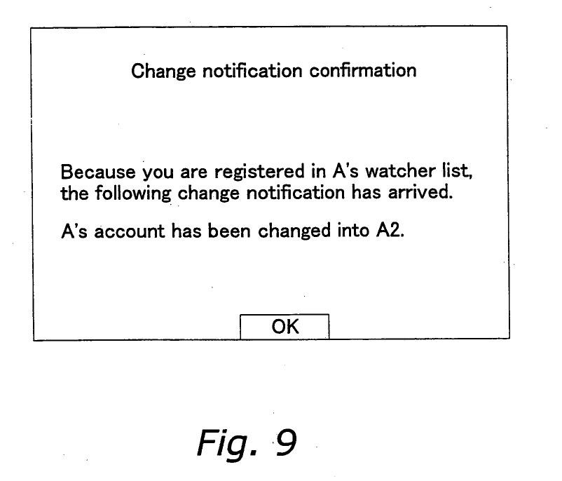

The change module 24 may transmit, to the clients to be notified, attribute information that is not set by the user agent A. FIG. 9 shows an example of a display screen that displays such attribute information. This example illustrates that the displayed attribute information reports that the new account has been reported because the notified client has been a watcher of the user agent A. This is advantageous in that the user agent who operates the notified client can be informed of why the account has been changed and why the new account is told to him/her.

The decision module 25 assigns all or some of the clients operated by watchers of the user agent A (hereafter referred to as watcher clients) as the notification recipients of the new account “A2” according to a change of the account of the client 2a, and produces a notification recipient list (not shown in the figure). The decision module 25 may update the watcher list table 12 so that the watcher list table 12 contains only the watchers who operate the watcher clients contained in the notification recipient list. This is because such watchers are considered to have a close relationship with the user agent A.

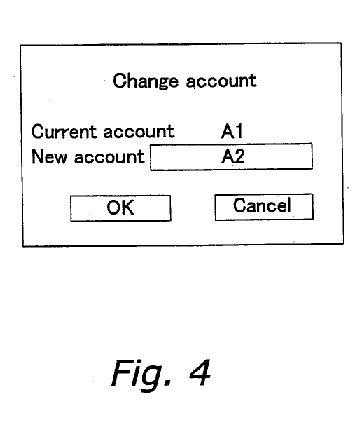

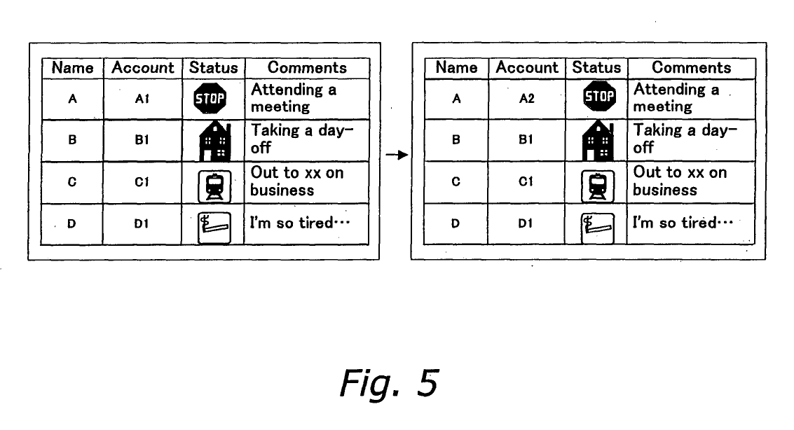

The notification module 26 reports the new account “A2” of the client 2a by transmitting an account change notification to the clients contained in the notification recipient list. FIG. 5 shows an example of a screen displayed on a client that receives the account change notification. In this example, the indication of the account of the user agent A (displayed as “A” in the figure) has been changed from “A1” to “A2”. The notification module 26 may provide the client to be notified with screen data for displaying the message reporting that the client 2a's account has been changed. FIG. 6 shows an example of a screen displayed on a client to be notified that is created based on the screen data. This example of the screen displays the change made to the account of the client 2a and its new account “A2”.

When a user agent A changes his/her account, the server 1 automatically determines and reports the notification recipient of the new account. The maximum range of the notification recipients of the new account is the watcher clients that are operated by the watchers of the user agent A. It is preferable that the notification recipients of a new account be determined so that unnecessary notification recipients are not included, taking into account the relationship between the user agent A and the user agents of the notification recipients. It can be safely assumed that the watchers of the user agent A are trusted by the user agent A and the user agent A wishes to notify them of the new account because they are the notification recipients of user agent A's presence information. In addition, it can be assumed that there is little need for reporting user agent A's new account to other users than the watchers who are shown the presence information of the user agent A.

2. Configuration in which Some of the Watchers are Notified

The decision module 25 may produce a notification recipient list according to a change of the account of the client 2a by extracting some of the watcher clients of the client 2a.

There are cases where a user agent A does not necessarily wish to notify all the watchers of his/her new account. If this is the case, some of the watchers are extracted, and the notification recipient list may be produced accordingly. The extracted watchers exclude those to whom the notification of the new account is assumed to be unnecessary. Examples of the method of extracting include: a) extracting the watchers who frequently receives the presence information of the user agent A, and b) extracting the watchers who frequently reports their presence information to the user agent A. In the following discussion, the methods of extracting some watchers are detailed with reference to FIGS. 1 to 3 and specific examples.

2.1 Extracting Watchers who are Buddies

As illustrated in FIG. 1, the server 1 may be provided with a buddy list table 13. The decision module 25 may decide those clients that are the watcher clients of the client 2a and are operated by buddies of the user agent A (hereafter referred to as “subscriber clients”) to be the notification recipients of the new account. Here, the term “the buddies of the user agent A” means the user agents whom the user agent A wishes to be notified of their presence information.

The buddy list table 13 stores a buddy list for each client. FIG. 3 shows a buddy list of the user agent A. In the figure, the user agent A designates the clients identified by the accounts “C1” and “D1” as his/her buddies.

For example, in FIG. 3, the account of the client 2 that is operated by a user agent who is a watcher and a buddy of the user agent A is “C1”. In this case, the decision module 25 decides the client identified by the account “C1” to be a notification recipient of the new account “A2”.

A buddy can be considered as a user agent that the user agent A has interest in. If a user agent who is both a watcher and a buddy of the user agent A is decided to be a notification recipient of the new account, it is expected that user agents having a close relationship with the user agent A can be selectively extracted from the watchers. Thus, those watchers who are inappropriate as the notification recipients of the new account are not notified of the new account. For example, those watchers who do not permit the user agent A to be notified of their presence information are not notified of the new account.

2.2 Extracting Watchers Based on Presence Notification History

As illustrated in FIG. 1, the server 1 may further be provided with a distribution module 22 and an extracting information table 14.

The distribution module 22 accepts a setting of presence information from a client 2, and distributes the new presence information to the watcher clients of the client (hereafter, this process is referred to as “presence notification”). Each watcher client 2 who has received the presence notification displays the presence information or updates the display of the presence information, as illustrated in FIG. 5.

The extracting information table 14 stores information for extracting some of the watchers. As shown in FIG. 3, the extracting information table 14 stores, for example, a presence reception list 142 and a presence transmission list 143 indicating the history of sending and receiving presence notification. The presence reception list 142 contains data indicating the history of receiving presence notification, such as the accounts of the clients from which the client 2a has received their presence information (hereafter referred to as “presence-received clients”), the number of times of receipt, and the time of receipt. The presence transmission list 143 contains data indicating the history of transmittance of presence notification, such as the accounts of clients to which the client 2a has transmitted his/her presence information (hereafter referred to as “presence-transmitted clients”), the number of times of transmission, and the time of transmission.

The decision module 25 may decide those clients that are watcher clients and presence-received clients of the client 2a to be the notification recipients of the new account by extracting such clients based on the presence reception list 142. Alternatively, it is possible to decide only those clients that are watcher clients and have a large number of times of receipt or a high frequency of receipt to be the notification recipients. In addition, it is possible to decide those clients that are such presence-received clients and subscriber clients to be notification recipients.

Likewise, the decision module 25 may decide those clients that are watcher clients and presence-transmitted clients of the client 2a to be the notification recipients of the new account by extracting them based on the presence transmission list 142. It is also conceivable that only those clients that are watcher clients and are presence-transmitted clients exhibiting a large number of times of transmission or a high transmission frequency are made the notification recipients. Further, it is possible to decide those clients that are such presence-transmitted clients and subscriber clients to be the notification recipients. In addition, it is also possible that being the foregoing presence-received client be added as a requirement for the notification recipient.

In the example shown in FIG. 3, the extracting information table 14 further includes a decision criterion value list 141. The decision module 25 produces a notification recipient list based on, for example, the watcher list 12, the presence notification sending history 142 and the presence notification receiving history 143, and the decision criterion value list 141. The decision criterion value list 141 stores various threshold values. For example, the threshold values for the number of times, frequencies or the like. In this example, the threshold value for the “number of times” is 10. Among the presence-received clients, the decision module 25 may extract a client “C1” that has 10 or more times of receipt and is a watcher client, as a notification recipient. Alternatively, among the presence-transmitted clients, the decision module 25 can extract a client “C1” that have 10 or more times of transmission and is a watcher client, as a notification recipient. It should be noted that in the example shown in FIG. 3, the notification recipient list consisting of the extracted notification recipients is replaced by a new watcher list 12.

When the histories of sending and receiving presence notification are used for extracting watchers, it is possible to prevent a notification of the new account to unnecessary clients. For example, even if a user agent X is a watcher and a buddy of the user agent A, the presence notification from the user agent X is not transmitted to the user agent A unless his/her presence information changes. It can be assumed that the need to notify such a user agent X of the new account is relatively low.

2.3 Extracting Watchers Based on Messaging History

As illustrated in FIG. 1, the server 1 may further be provided with an IM (Instant Messaging) module 23 and an extracting information table 14.

The IM module 23 accepts a setting of a text message and designation of its destination from a client 2, and distributes the text message to the destination.

The extracting information table 14 stores the information for extracting some of the watchers. As shown in FIG. 3, the extracting information table 14 stores, for example, a message reception list 144 and a message transmission list 145 that indicate the history of sending and receiving text messages. The message reception list 144 contains data indicating the history of receiving text messages, such as the accounts of clients from which the client 2a has received text messages (hereafter referred to as “message-received client”), the number of times of receipt, and the time of receipt. The message transmission list 145 contains data indicating the history of transmitting text messages, such as the accounts of clients to which the client 2a has transmitted a text message (hereafter referred to as “message-transmitted clients”), the number of times of transmission, and the time of transmission.

The decision module 25 may decide those clients that are watcher clients of the client 2a and the message-received clients to be the notification recipients of the new account by extracting them based on the message reception list 144. It is also possible to decide only the clients that are watcher clients and are message-received clients exhibiting a large number of times of receipt or a high frequency of receipt of text messages to be the notification recipients. In addition, it is conceivable to decide those clients that are such message-received clients and subscriber clients to be the notification recipients.

Likewise, the decision module 25 may decide those clients that are watcher clients of the client 2a and message-transmitted clients to be the notification recipients of the new account by extracting them based on the message transmission list 145. It is also possible to decide only those clients that are watcher clients and are message-transmitted clients exhibiting a large number of times of transmission or a high transmission frequency of text messages to be the notification recipients. In addition, it is conceivable to decide those clients that are message-transmitted clients and subscriber clients to be the notification recipients.

In the example shown in FIG. 3, the extracting information table 14 includes a decision criterion value list 141. The decision module 25 produces a notification recipient list based on the watcher list 12, the presence notification sending history 142 and the presence notification receiving history 143, and the decision criterion value list 141. The decision criterion value list 141 stores various threshold values, for example, a threshold value “10” for the number of times. In this example, among the message-received clients, the decision module 25 may extract clients “C1” and “Y1” that have 10 or more times of receipt and that are watcher clients, as the notification recipients. Alternatively, among the message-received clients, the decision module 25 can extract a client “C1” that has 10 or more times of transmission and that is a watcher client, as a notification recipient.

It can be assumed that the user agents who have exchanged text messages with the user agent A have relatively a close relationship with the user agent A. Therefore, it can be inferred that a user agent who is both one of such user agents and a watcher of the user agent A is appropriate to be notified of the new account.

2.4 Extracting Watchers According to Access Levels

As illustrated in FIG. 2, the presence table 11 may store client 2's presence information so that it is associated with an access level that limits the notification recipients of client 2's presence information. An access level means a level of disclosure of presence information. In FIG. 2, the client 2 can set presence information corresponding to each access level.

When access levels are set in the presence table 11, it is preferable that the watcher list table 12 further stores the access level of each of the watchers as illustrated in FIG. 3. The access level of each watcher is set by a presentity who provides his/her presence information to the watcher. In FIG. 3, the user agent A is the presentity.

In this case, the decision module 25 can determine all or some of client 2a's watcher clients as the notification recipients of the new account, based on the access level of each watcher. For example, as shown in FIG. 3, the extracting information table 14 is provided with the decision criterion value list 141, in which an access level threshold value of “2” is registered. In the example shown in FIG. 3, the decision module 25 extracts clients “B1”, “C1”, and “Y1”, operated by the watchers who have an access level value of 2 or less, as the notification recipients of the new account.

It can be assumed that an access level represents the level of trust of the user agent A. Accordingly, by controlling notification recipients based on their access levels, for example, by determining a user agent having a high access level as a notification recipient, it is possible to prevent unnecessary notifications of accounts.

2.5 Other Extraction Techniques

If various values are set in the extracting information table 14 according to the watcher list table 12, appropriate watchers can be extracted as the notification recipients in various methods. As illustrated in FIG. 3, when the watcher list table 12 stores “display flag”, “display sequence”, and “display color”, criterion values corresponding to these settings can be set into the decision criterion value list 141 of the extracting information table 14. FIG. 3 shows an example of the settings made in the decision criterion value list 141. This figure shows the setting for extracting those watcher clients whose “display flags” are on as notification recipients. Although the extraction based on the display sequence or the display color is not shown in this example, it is possible to extract notification recipients using these values. For example, if the display sequence is set to be up to 2, then the clients “B1” and “C1” become notification recipients in this example. If the display color is set as “blue”, the client “B1” becomes a notification recipient in this example.

In another method, when the watcher list table 12 stores “elapsed time” as shown in FIG. 3, a threshed value for elapsed time can be set in the decision criterion value list 141 of the extracting information table 14 (not shown in the figure). For example, when the “elapsed time” represents an elapsed time from the point when a client has become a watcher client of the client 2a, those watcher clients that show elapsed times longer than a predetermined time can be extracted as the notification recipients. Those user agents having watcher clients that show long elapsed time can be assumed to have a long term relationship with the user agent A. Accordingly, it is possible that those long time watcher clients are notified of the account while those watcher clients that are considered to have a short-term relationship may be omitted from the notification recipients.

In further another method, when the watcher list table 12 stores “numbers of times” as shown in FIG. 3, a threshold value of the number of times may be set in the decision criterion value list 141 of the extracting information table 14. For example, when the “number of times” represents the number of times of notification of client 2a's is presence information, those watcher clients exhibiting a number of times of notification that is greater than a predetermined number can be extracted as the notification recipients. This is because it can be considered that such clients have relatively a close relationship with the user agent A.

The foregoing are examples of decision criteria and extraction methods for extracting appropriate watchers as notification recipients of a new account. These decision criteria and extraction methods can be combined as appropriate. Also, according to the need, other decision criteria and extraction methods may be employed as appropriate.

3. Client that is a Change Notification Recipient

The client that has received a change notification of an account operates as follows. For example, assume that a client 2b operated by a user agent B has received a change notification of the account of a client 2a. The client 2b searches whether various stored information contains the old account “A1” that is contained in the change notification of the account. Here, it is assumed that the user agent B has registered user agent A's account “A1” in the buddy list, and further has set his/her access level.

When the client 2b receives the change notification of an account, the client 2b may automatically change the account “A1” that has been registered in the buddy list or in the access level to be the new account “A2” that has been notified. In addition, the client 2b may display types of information that contain the account “A1”, which is the subject of the change notification, on its screen, as shown in FIG. 6. The client 2b may accept selection of type(s) of information in which the change is to be reflected from the user agent B, and thereafter change the account into the account “A2” only for the type(s) of information that has/have been specified on the screen.

4. Process Flow

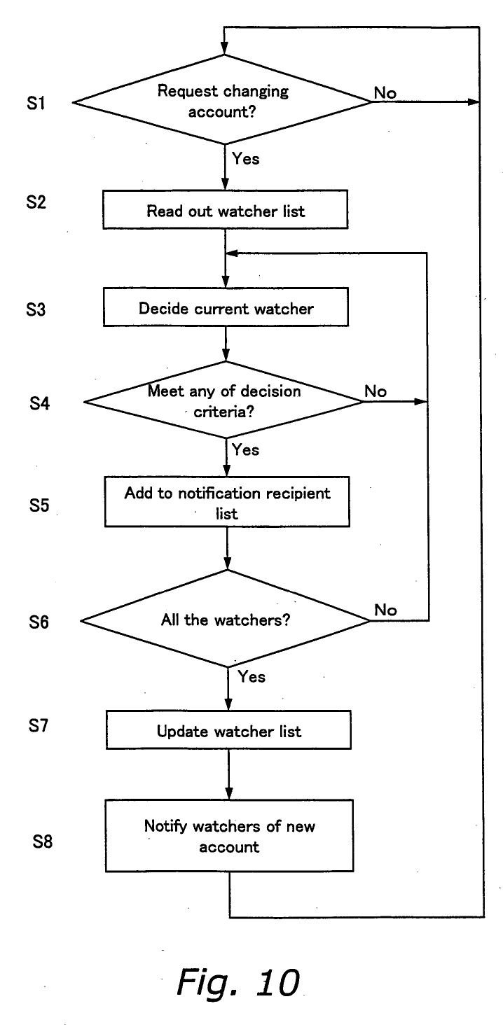

FIG. 10 is a flowchart illustrating an example of the flow of a notification process carried out by the server 1. For convenience in illustration, it is assumed here that the extracting information table 14 has such contents as illustrated in FIG. 3, and the following describes an example of a process in which a watcher who satisfies any of the decision criteria illustrated in the foregoing, is decided to be a notification recipient.

Step S1: The change module 24 proceeds to step S2 when it receives an account change request from a given client. Here, it is assumed that there has been an account change request from the client 2a.

Step S2: The decision module 25 reads out client 2a's watcher list from the watcher list table 12.

Step S3: The decision module 25 decides any one of the watcher clients contained in the watcher list to be a current watcher.

Step S4: The decision module 25 judges whether the current watcher satisfies any one of decision criteria or not. When the current watcher satisfies any one of the decision criteria, such as whether the current watcher is a buddy of the user agent, or whether the current watcher has an access level of 2 or lower, the process proceeds to step S5. When the current watcher does not satisfy any of the decision criteria, the process returns to step S3, and the foregoing judgment is repeated, assigning another watcher as a current watcher.

Step S5: The decision module 25 adds the current watcher to the notification recipient list.

Step S6: The decision module 25 judges whether or not the watcher clients of all user agent A's watchers have been subjected to the judgment in the step S4. If yes then the process proceeds to step S7. If “no”, then the process returns to step S3 and the foregoing steps S3 through S5 are repeated assigning another watcher client as a current watcher.

Step S7: The decision module 25 updates the watcher list table 12 so that it contains only the clients contained in the notification recipient list.

Step S8: The notification module 26 notifies the clients contained in the updated watcher list of client 2a's new account. At this time, it is also possible to report attribute information such as the reason for the notification therewith.

Other Embodiments

(A) Notification recipients of the new account “A2” of the user agent A may be determined as follows. First, the server 1 is provided with a function of forwarding text messages, and the lists of recipients of forwarded messages for respective user agents are stored in the server 1 (not shown in the drawings). When user agent A's account is changed, the user agents registered as user agent A's recipients of forwarded messages are determined as the notification recipients of the new account “A2”.

(B) A user agent B who has been notified of user agent A's new account may request the new account “A2” to send a notification of presence information again. Thus, user agent A's presence information can be unfailingly obtained even after the account has been changed.

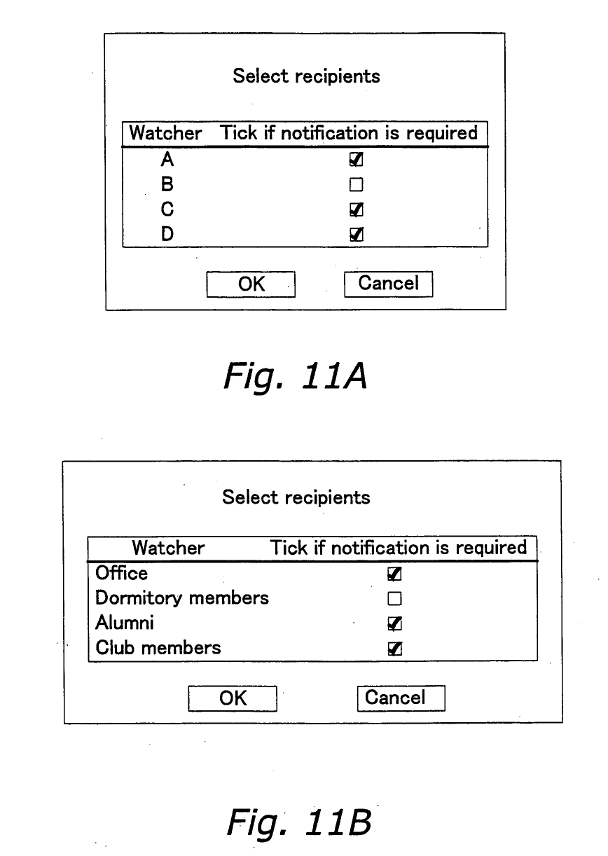

(C) Notification recipients of a new account may be made manually selectable from the watcher list or from the list of user agents who are both watchers and buddies. This selection may be made in individuals or in groups. FIG. 11A shows an example of screen for selecting notification recipients of a new account from the watcher list. FIG. 11B shows an example of screen for selecting notification recipients of a new account from the group of users who are both watchers and buddies.

(D) The foregoing presence system is generally achieved by a server-client system, but the invention is not limited thereto. The invention is also applicable to “P2P” systems, in which clients exchange their presence information each other.

(E) In the above embodiments, notification recipients of an account are determined based on the information registered in a watcher list. However, it is possible to refer to a buddy list and to determine the accounts of the clients registered in the buddy list as the account notification recipients.

Accordingly, it is possible to make a change notification of client 2a's account only to the other clients 2b, 2c, . . . etc. who are recognized by the client A, regardless of whether or not the clients refer to client 2a's presence. Thus, an account change notification is not made to those other client 2x (not shown in the drawings) who have referred to the presence information of the client 2a in an unauthorized manner, and therefore, it is made possible to eliminate unauthorized watchers of the client 2a.

In addition, if the client 2a utilizes a permission list in which those other clients 2d, 2e, . . . etc. that are permitted to refer to client 2a's presence information are registered, it is possible to notify other clients 2d, 2e . . . etc. (not shown in the drawings) that are not registered in the buddy list. Because those clients 2d, 2e, . . . etc. that are registered in the permission list are the clients to whom the client 2a gives permission to refer to his/her presence information, they are allowed to know client 2a's account. Thus, regardless of whether or not there is a reference relationship of presence information, those clients to whom the client 2a gives permission to refer to his/her accounts are selected as the recipients of an account change notification.

Those clients 2y, 2z, . . . (not shown in the drawings) that are registered in the rejection list for rejecting a notification of client A's presence information are, in other words, a set of clients that cannot be the recipients of an account change notification. The rejection list is effective when used for checking if the change notification recipients extracted based on various information contains a client that is not to be notified. Checking is made on whether a client extracted as a change notification recipient is contained in the rejection list, and if contained in the list, the client is excluded from the change notification recipients. In this manner, it is possible to automatically exclude those clients that are not to be notified of the change.

History information that stores past presence information and the clients that were recipients and transmitters of messages are the data that can be used for inferring the degree of intimacy between a client and another client that is a communication partner therewith. From the history information, presence information, the frequency of transmission and reception of messages, and/or the time interval thereof are analyzed, and for example, those clients with high frequencies and/or narrow time intervals are extracted as the change notification recipients. Thus, it is possible to select change notification recipients according to the relationship between a client and another client that is a communication partner therewith at the time of the account change notification.

(F) The present invention encompasses storage media that record programs that execute the foregoing methods according to the present invention. Such storage media may include computer-readable/writable flexible disks, hard disks, semiconductor memories, CD-ROMs, DVDs, magneto-optical disks (MOs), and others.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. A client administration method of administering a group of clients, each client providing presence information, the method comprising:
a presence-storing step of accepting a setting of presence information of the clients including a first client, and storing the presence information client by client;
a notification recipient-storing step of storing identifiers of watcher clients for respective clients, each of the watcher clients being provided with the presence information of at least one of the clients in the clients group;
an identifier-changing step of accepting a change of the identifier of the first client;
a decision step of deciding a watcher client of the first client or at least one of a plurality of watcher clients of the first client to be one or more identifier notification recipients according to the change of the identifier of the first client; and
an identifier-transmitting step of transmitting a new identifier of the first client to one or more identifier notification recipients decided in said decision step.

2. The client administration method as set forth in claim 1, wherein the decision step deciding all of a plurality of watcher clients of the first client to be identifier notification recipients according to the change of the identifier of the first client.

3. The client administration method as set forth in claim 1, further comprising:
a subscriber client-storing step of storing identifiers of subscriber clients so that each subscriber client is associated with at least one client that provides the presence information thereto, the subscriber client being provided with the presence information of at least one client of the clients group; and
said decision step deciding a client to be an identifier notification recipient, the client being both a watcher client of the first client and a subscriber client of the first client.

4. The client administration method as set forth in claim 1, further comprising:
a presence-notifying step of notifying the first client's watcher client of new presence information according to the setting of the presence information;
a notification history-storing step of storing a notification history of the presence information; and
said decision step extracting at least one of a plurality of watcher clients of the first client based on the notification history, and deciding to be one or more identifier notification recipients.

5. The client administration method as set forth in claim 1, further comprising:
a messaging step of administering distribution of text messages exchanged between the clients;
a distribution history step of storing a distribution history of distributed text messages; and
said decision step extracting at least one of a plurality of watcher clients of the first client based on the distribution history, and deciding to be one or more identifier notification recipients.

6. The client monitor method as set forth in claim 1, wherein:
said presence-storing step storing the presence information of the clients so that the presence information is associated with an access level, the access level limiting notification recipients of the presence information of the clients;
said notification recipient-storing step further storing the access level of each watcher client; and
said decision step deciding a portion of a plurality of watcher clients of the first client to be the identifier notification recipients based on the access level of each watcher client.

7. The client administration method as set forth in claim 1, wherein, said identifier-transmitting step further transmitting display data for displaying the change of the identifier of the first client to one or more identifier notification recipients.

8. The client administration method as set forth in claim 1, wherein said identifier-transmitting step further transmitting attribute information related to the change of the identifier of the first client to one or more identifier notification recipients.

9. The client administration method as set forth in claim 8, wherein said identifier-changing step accepting registration of the attribute information.

10. A client administration device that administers a group of clients, each client providing presence information, the device comprising:
presence-storing unit for accepting a setting of presence information of the clients including a first client, and storing the presence information client by client;
notification recipient-storing unit for storing identifiers of watcher clients for respective clients, each of the watcher clients being provided with the presence information of at least one of the clients in the clients group;
identifier-changing unit for accepting a change of the identifier of the first client;
decision unit for deciding a watcher client of the first client or at least one of a plurality of watcher clients of the first client to be one or more identifier notification recipients according to the change of the identifier of the first client; and
identifier-transmitting unit for transmitting a new identifier of the first client to one or more identifier notification recipients decided by said decision unit.

11. A computer-readable storage medium storing a client administration program for administering a group of clients, each client providing presence information, the program executing:
a presence-storing step of accepting a setting of presence information of the clients including a first client, and storing the presence information client by client;
a notification recipient-storing step of storing identifiers of watcher clients for respective clients, each of the watcher clients being provided with the presence information of at least one of the clients in the clients group;
an identifier-changing step of accepting a change of the identifier of the first client;
a decision step of deciding a watcher client of the first client or at least one of a plurality of watcher clients of the first client to be one or more identifier notification recipients according to the change of the identifier of the first client; and
an identifier-transmitting step of transmitting a new identifier of the first client to one or more identifier notification recipients decided in said decision step.

12. A client administration program executed by a computer that administers a group of clients, each client providing presence information, the program causing the computer to execute the steps of:
a presence-storing step of accepting a setting of presence information of the clients including a first client, and storing the presence information client by client;
a notification recipient-storing step of storing identifiers of watcher clients for respective clients, each of the watcher clients being provided with the presence information of at least one of the clients in the clients group;
an identifier-changing step of accepting a change of the identifier of the first client;
a decision step of deciding a watcher client of the first client or at least one of a plurality of watcher clients of the first client to be one or more identifier notification recipients according to the change of the identifier of the first client; and
an identifier-transmitting step of transmitting a new identifier of the first client to one or more identifier notification recipients decided in said decision step.

13. A client administration method of administering a group of clients, each client providing presence information, the method comprising:
a presence-storing step of accepting a setting of presence information of the clients including a first client, and storing the presence information client by client;
information-storing step of storing client-relationship information for respective clients, the client-relationship information containing one or more identifiers of one or more clients relating to provision of presence information of the first client thereto and/or one or more identifiers of one or more clients relating to a request made by the first client, the request being for provision of presence information of those clients to the first client;
an identifier-changing step of accepting a change of the identifier of the first client;
a decision step of deciding one or more clients to be one or more identifier notification recipients according to the change of the identifier of the first client, one or more identifiers of one or more clients being contained in the client relationship information stored in association with the first client; and
an identifier-transmitting step of transmitting a new identifier of the first client to one or more identifier notification recipients decided in said decision step.
